(19) United States
(12) Patent Application Publication
(10) Pub. No.: US 2009/0280397 A1
(43) Pub. Date: Nov. 12, 2009

(54) BATTERY HOLDING STRUCTURE FOR ELECTRONIC DEVICE

(75) Inventor: Yue-Hui Lv, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/233,763

(22) Filed: Sep. 19, 2008

(30) Foreign Application Priority Data
May 9, 2008 (CN) 200810301522.X

(51) Int. Cl. H01M 2/10

(52) U.S. Cl. 429/100

(57) ABSTRACT

A battery holding structure (100) for holding a battery (3) inside an electronic device includes a housing (1), an elastic sheet (26), and a block (112). The housing defines a battery chamber (10) and includes a top sidewall (11) and a bottom sidewall (15). The elastic sheet is formed on a bottom sidewall. The block is formed on the top sidewall. The elastic sheet is compressed by the battery to be held within the electronic device such that the battery is secured in the battery chamber by the block.

### BACKGROUND

1. Field of the Invention

The invention relates to battery holding structures used in an electronic devices.

2. Description of Related Art

With rapid development of information technology, electronic devices, such as cellular phones, personal digital assistant (PDA), and so on, are become more and more popular. Batteries are usually carried with the electronic devices by the battery holding structures and used to supply power for the electronic devices.

A typical battery holding structure has elastic connector pins for easy installation or removal of the battery. The connector pins electrically connect the battery with the electronic device. However, elastic connector pins can easily wear out from frequent installation/removal of the battery. Accordingly, the electrical connection between the battery and the electronic device can be degraded by the wear-out of the connector pins. The battery thus cannot normally supply power to the electronic device.

Therefore, there is room for improvement within the art.

### BRIEF DESCRIPTION OF THE DRAWINGS

Many aspects of an exemplary battery holding structure for an electronic device can be better understood with reference to the following drawings. These drawings are not necessarily drawn to scale, the emphasis instead being placed upon clearly illustrating the principles of the exemplary battery holding structure. Moreover, in the drawings like reference numerals designate corresponding parts throughout the several views. Wherever possible, the same reference numbers are used throughout the drawings to refer to the same or like elements of an embodiment.

FIG. 1 is an isometric view of a battery and a battery holding structure for an an electronic device according to the exemplary embodiment.

FIG. 2 is another view of the battery holding structure and the battery shown in FIG. 1 from a different angle.

FIG. 3 is a view of the battery hold by the battery holding structure shown in FIG. 1.

FIG. 4 is another view of the battery hold by the battery holding structure shown in FIG. 1 from a different angle.

### DETAILED DESCRIPTION OF THE EXEMPLARY EMBODIMENTS

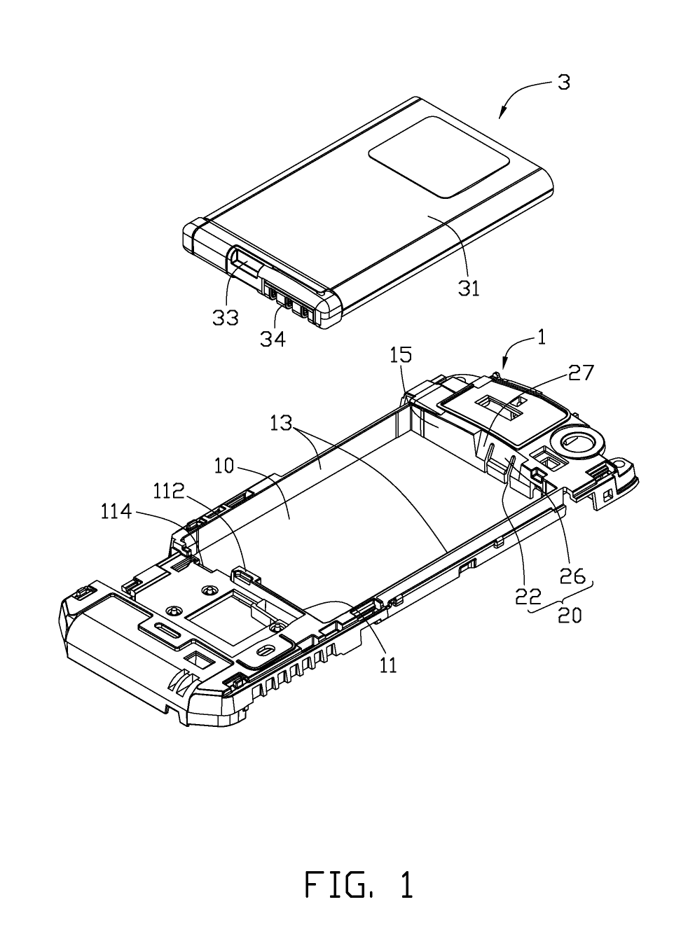

FIG. 1 shows an exemplary battery holding structure 100 that can be used to hold a battery 3 within a housing 1 of an exemplary electronic device (such as cellular phone). The battery 3 supplies power to the electronic device.

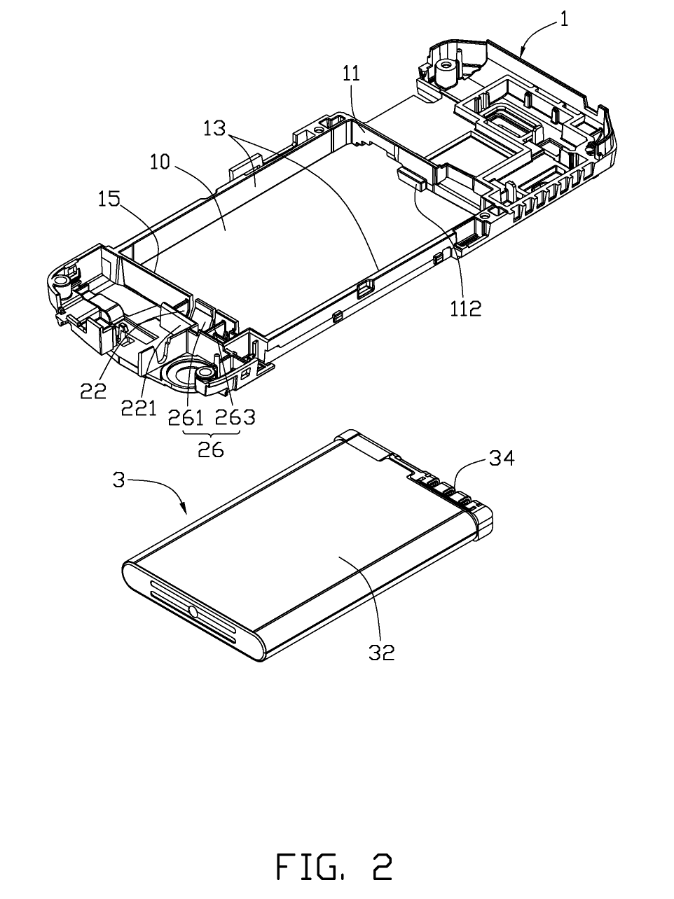

The housing 1 defines a generally rectangular battery chamber 10 for receiving the battery 3. The battery chamber 10 is enclosed by a top sidewall 11, two opposite sidewalls 13, and a bottom sidewall 15. The top sidewall 11 has a block 112 protruding therefrom and extending partially over (above) the bottom sidewall 15, and top sidewall 11 defines a slit 114 for receiving pins of a connector (not shown). The bottom sidewall 15 defines a mounting area 20. Mounting area 20 defines a recess 22 (also seen in FIG. 2), an elastic sheet 26 and a slant wall 227. The elastic sheet 26 extends from the bottom wall 221 of the recess 22 towards the battery chamber 10. The elastic sheet 26 separates the recess 22 from the battery chamber 10 (best seen in FIG. 2).

The elastic sheet 26 is generally rectangular including a connecting portion 261 and a resisting portion 263. The connecting portion 261 connects the resisting portion 263 with the bottom sidewall 15 (best seen in FIG. 2). The resisting portion 263 extends beyond the bottom sidewall 15. The slant wall 227 is located parallel with the connecting portion 261 and used to facilitating the installation or removal of the battery 3 relative to the battery chamber 10.

The battery 3 is configured to be received and secured in the battery chamber 10. An upper wall 31 of the battery 3 defines a groove 33 corresponding to the block 112. A lower wall 32 of the battery 3 has electrodes 34 corresponding to the pins (not shown). The battery 3 can supply power to the electronic device through the contacting of the electrodes 34 with the pins.

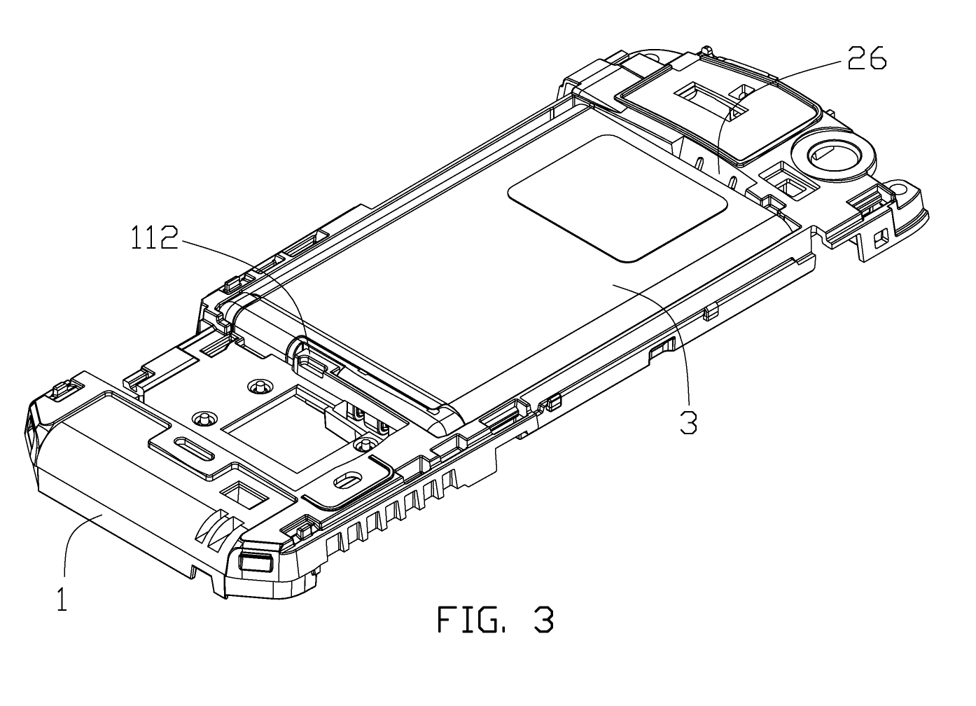

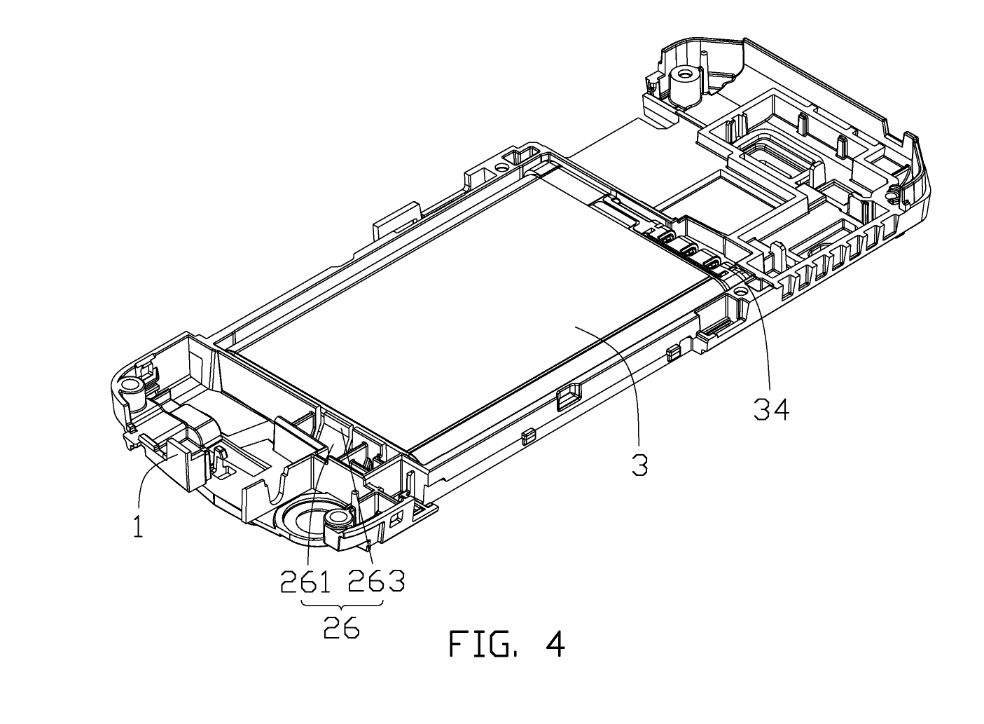

Referring to FIGS. 3 and 4, the battery 3 is installed in the battery chamber 10. The resisting portion 263 of the elastic sheet 26 is compressed by a side of the battery 3. The groove 33 receives and secures the block 112 there in. The compressed resisting portion 263 and the secured block 112 cooperatively hold the battery 3 in the battery chamber 10.

To remove battery 3 from the battery chamber 10, the elastic sheet 26 may be further compressed (e.g., by an user's finger compressing the connecting portion 261) until the resisting of the resisting portion 263 against the battery 3 is removed. At such time, the battery 3 can be simply raised to detach from the battery chamber 10.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery holding structure for holding a battery inside an electronic device, comprising:
a housing defining a battery chamber comprising a top sidewall and a bottom sidewall;
an elastic sheet formed on a bottom sidewall of the housing; and
a block formed on the top sidewall;
wherein the elastic sheet is compressed by the battery to be held within the electric device such that the battery is secured in the battery chamber by the block.

2. The battery holding structure as claimed in claim 1, wherein the bottom sidewall defines a recess, the elastic sheet extending from the bottom wall of the recess towards the battery chamber and beyond the bottom sidewall.

3. The battery holding structure as claimed in claim 2, wherein the elastic sheet blocks communication of the battery chamber with the recess.

4. The battery holding structure as claimed in claim 2, wherein the elastic sheet comprises a connecting portion and a resisting portion, the connecting portion connecting the resisting portion with the bottom wall, the resisting portion extending beyond the bottom sidewall.

5. The battery holding structure as claimed in claim 4, wherein the bottom sidewall forms a slant wall around the elastic sheet and parallel to the connecting portion.

6. The battery holding structure as claimed in claim 4, wherein the resisting portion is elastically compressed by the battery.

7. The battery holding structure as claimed in claim 6, wherein the block protrudes from the top sidewall and extending partially above the bottom sidewall, the battery defines a groove configured to receive the block therein.

8. A battery holding structure for holding a battery inside an electronic device, comprising:
a housing defining a battery chamber and comprising a first and second sidewalls;
an elastic sheet extending beyond the first sidewall into the battery chamber; and
a block extending from the second sidewall within the battery chamber;
wherein the battery can be secured in the battery chamber by the elastic sheet and the block.

9. The battery holding structure as claimed in claim 8, wherein the first sidewall defines a recess, the elastic sheet extending from the bottom wall of the recess towards the battery chamber and beyond the first sidewall.

10. The battery holding structure as claimed in claim 9, wherein the elastic sheet blocks communication of the battery chamber with the recess.

11. The battery holding structure as claimed in claim 9, wherein the elastic sheet comprises a connecting portion and a resisting portion, the connecting portion connecting the resisting portion with the bottom wall, the resisting portion extending beyond the first sidewall.

12. The battery holding structure as claimed in claim 11, wherein the first sidewall forms a slant wall around the elastic sheet and parallel to the connecting portion.

13. The battery holding structure as claimed in claim 11, wherein the resisting portion is elastically compressed by the battery.

14. The battery holding structure as claimed in claim 13, wherein the block protrudes from the second sidewall and extending partially above the bottom sidewall, the battery defines a groove configured to receive the securing block therein.
